(19) United States
(12) Patent Application Publication
(10) Pub. No.: US 2021/0279684 A1
(43) Pub. Date: Sep. 9, 2021

(54) ASSET MANAGEMENT STRATEGY USING DISPLAY OF CONTEXTUAL CUES TO ASSIST IN ZONE DEFINITION

(71) Applicant: Caterpillar Inc., Peoria, IL (US)

(72) Inventors: Nicholas Adam Hanauer, Washington, IL (US); Timothy Edward Noon, Morton, IL (US); Chad Timothy Brickner, Dunlap, IL (US); Allen J. DeClerk, Princeton, IL (US)

(73) Assignee: Caterpillar Inc., Peoria, IL (US)

(21) Appl. No.: 17/184,176

(22) Filed: Feb. 24, 2021

Related U.S. Application Data
(60) Provisional application No. 62/986,272, filed on Mar. 6, 2020.

(51) Int. Cl. G06Q 10/10; G09G 5/37; G06F 3/14; G06F 3/0484; G06Q 10/06; G07C 5/00; G06Q 50/02; E02F 9/26; G01S 19/51

(52) U.S. Cl. CPC G06Q 10/103; G09G 5/37; G06F 3/14; G06F 3/0484; G09G 2354/00; G07C 5/008; G06Q 50/02; E02F 9/261; G01S 19/51; G06Q 10/0639

(57) ABSTRACT

A machine system includes machine assets structured for material handling at a work site, and an asset management system including a display and at least one computer. The at least one computer is structured to display a graphical map representation of the work site based upon stored terrain data on the display. The at least one computer is further structured to populate the graphical map representation with a posteriori contextual image cues, and update a performance tracking plan based upon at least one of a zone or a boundary at the work site as specified by a user. The at least one computer is still further structured to store a history of asset performance at the work site based upon the updated performance tracking plan. Related methodology and control logic are also disclosed.

### TECHNICAL FIELD

The present disclosure relates generally to managing assets at a work site, and more particularly to assisting a user with contextual image cues in configuring an asset performance tracking plan.

### BACKGROUND

Management of machine assets at work sites for improved efficiency is of great interest to operations managers and others in mining, quarrying, construction, and other industries. Such operations can be quite complex and for optimized efficiency can require simultaneous monitoring, evaluation, and control of numerous diverse machine assets. In a quarrying application, for example, a first group of machines may be tasked with obtaining raw material and loading the raw material into off-highway haul trucks for transport to a pile, a crusher, or other asset for further processing. Other machine assets may be tasked with feeding the material for processing to the crusher or other machinery, and loading on-highway haul trucks with processed material for dispatch. Other machine assets may have support roles, and are tasked with leveling or distribution of material, manipulation of moisture content, delivery or retrieval of fuel, supplies, or personnel, and still others.

The orchestration of the numerous machine assets is commonly monitored and managed using computerized site management and operations software. In an effort to optimize productivity, safety, fuel efficiency, and other parameters, performance metrics for some or all of the machine assets are typically calculated and displayed to an operations manager or other personnel in a visually perceptible format. Numbers of loads, percentage utilization of theoretical load capacity, load locations, dump locations, machine run time, duty cycle, and numerous other factors are quantified so that corrective action or strategic planning can be implemented. In many such computer-implemented systems data acquisition is based at least in part upon locations and travel paths of the various machine assets. For example, in one known application a data gathering zone can be defined by a user within which a particular segment or classification of machine activities are to be monitored, and quantified for performance metric purposes.

One known application for work site zone mapping in the context of collision avoidance is set forth in United States Patent Application Publication No. 2009/003462. In the '462 application, a work site mapping system has a receiving module that receives a position and a characteristic of an object at a work site, and a positioning device that determines a position of a mobile machine at the work site. A controller in communication with the receiving module and the positioning device generates an electronic map of the work site, and initiates a collision avoidance strategy in response to a mobile machine entering a boundary zone. While the '462 application proposes strategies that have certain applications, there is always room for improvement and alternative utilization of mapping information and user specifications in machine asset systems.

### SUMMARY OF THE INVENTION

In one aspect, a method of managing assets at a work site includes displaying, on a user interface, a graphical map representation of a work site based upon stored terrain data. The method further includes populating the graphical map representation displayed on the user interface with a posteriori contextual image cues. The method further includes receiving user-specified location parameters defining at least one of a zone or a boundary at the work site, and updating a performance tracking plan based upon the at least one of a zone or a boundary at the work site. The method still further includes storing a history of asset performance at the work site based upon the updated performance tracking plan.

In another aspect, a work site productivity management system includes a user interface having a display, and at least one computer coupled with the user interface. The at least one computer is structured to display, on the user interface, a graphical map representation of a work site based upon stored terrain data. The at least one computer is further structured to populate the graphical map representation displayed on the user interface with a posteriori contextual image cues, and receive user-specified location parameters defining at least one of a zone or a boundary at the work site. The at least one computer is still further structured to update a performance tracking plan based upon the at least one of a zone or a boundary at the work site, and store a history of asset performance at the work site based upon the updated performance tracking plan.

In still another aspect, a machine system includes a plurality of machine assets each structured for material handling at a work site, and an asset management system including a user interface having a display, and at least one computer coupled with the user interface. The at least one computer is structured to display, on the user interface, a graphical map representation of the work site based upon the stored terrain data, and populate the graphical map representation displayed on the user interface with a posteriori contextual image cues. The at least one computer is further structured to receive user-specified location parameters defining at least one of a zone or a boundary at the work site, and update a performance tracking plan based upon the at least one of a zone or a boundary at the work site. The at least one computer is still further structured to store a history of asset performance at the work site based up on the updated performance tracking plan.

### BRIEF DESCRIPTION OF THE DRAWINGS

FIG. 1 is a diagrammatic view of a machine system, according to one embodiment;

FIG. 2 is a block diagram illustrating example elements of an asset management system, according to one embodiment;

FIG. 3 is a view of a graphical map representation of a work site, according to one embodiment;

FIG. 4 is another view of a graphical map representation, according to one embodiment;

FIG. 5 is yet another view of a graphical map representation, according to one embodiment; and

FIG. 6 is a flowchart illustrating example methodology and logic flow, according to one embodiment.

### DETAILED DESCRIPTION

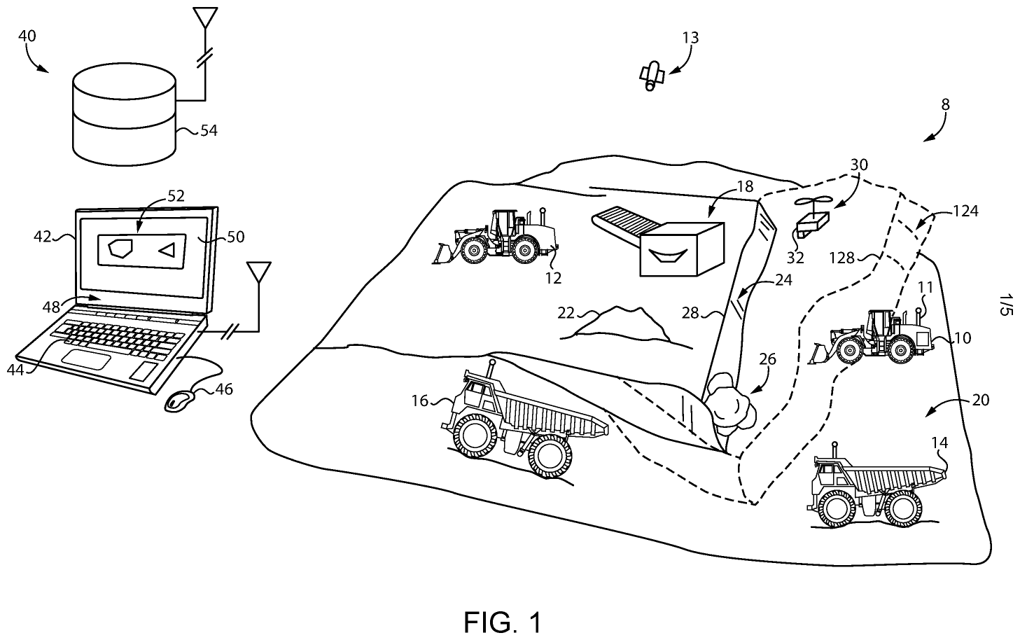

Referring to FIG. 1, there is shown a machine system 8 according to one embodiment, and including a plurality of machine assets each structured for material handling at a work site. The machine assets of machine system 8 can include a first loader 10, a second loader 12, a first off-highway haul truck 14, and a second off-highway haul truck 16. In the illustrated embodiment, a total of four mobile machine assets are shown, however, it should be appreciated that in other embodiments fewer assets, or a great many more might be used. Loader 10 is shown as it might appear in a quarry pit 10 or the like, tasked with loading material into a nearby one of haul trucks 14 or 16 in a typical work cycle. Loader 12 is shown as it might appear tasked with loading material delivered by haul trucks 14 and 16 into a crusher 18 or other processing equipment, which outputs processed material that can then be loaded using loader 12 or another asset into an on-highway truck or other conveyance mechanism. Machine system 8 is shown implemented in the context of a quarrying operation, however, it should be appreciated that the present disclosure will find application to a variety of other operations such as mining, construction, road building, or still others. Each of machine assets 10, 12 and 14, 16 and others that might be used can be equipped with apparatus for receiving location information, such as signals from global positioning system (GPS) satellites, one of which is shown at 13, or from a local positioning system. Loader 10 is shown equipped with a transmitter/receiver 11 for receiving location information, and feeding location data for loader 10 periodically, or more or less continuously, to an asset management system 40 further discussed herein. Each of the other machine assets of machine system 8 may be similarly equipped.

Also in FIG. 1 are depicted certain features of the work site, including a working face 24 and an elevation profile 28 above or at the top of working face 24. A prior working face is depicted at 124 and associated with a prior elevation profile 128. Removal of material has changed the terrain of the work site, and in the illustrated case has also revealed formerly buried objects 26, such as boulders. Conditions at the work site, including but not limited to terrain conditions, presence or absence of objects, and other conditions have been altered over the course of time by the removal of material. For this reason, management strategies and plans put in place that were configured and optimized for earlier conditions may no longer be suited for optimized efficiency and machine asset performance. Also shown in FIG. 1 is a field device 30, for example a drone including a sensor 32 such as a camera, or another sensor, that can obtain additional or updated information that can be implemented in an updated management plan and strategies for tracking performance of machine system 8 as further discussed herein.

As noted above, machine system 8 also includes an asset management system 40. In the illustrated embodiment, asset management system 40 includes a server computer 54 and a user computer 42. Server computer 54 may be in communication, directly or indirectly, with one or more of assets 10, 12 and 14, 16 and can gather performance data such as productivity data and utilization data based upon data feeds outputted from one or more of assets 10, 12 and 14, 16. User computer 42 can include a user interface 48 including a display 50 and one or more input devices such as a keyboard 44 and a computer mouse 46. Graphics 52 are displayed on display 50, and can include interactive graphics by which a user manipulates a performance tracking plan such as by way of specifying location parameters as further discussed herein.

As noted above, work site conditions can change over time based on the removal of material, the discovery of objects, or conditions of the material such as freezing, thawing, changes in moisture or composition, introduction or removal of different machine assets, or updated or improved machine asset technologies, or other factors. In a typical asset management strategy, users will often define boundaries or zones of a work site that serve as geolocation points, fences, or features that drive the gathering of machine asset performance data. In many instances, the basis for locating such boundaries or zones can include terrain data or other map data that is stored on a computer system and not updated in real time. In other words, a site manager or the like can plan machine activities and operations based upon a set of map parameters existing at a given time, but later discover that changed terrain conditions, or other map parameters, render the prior plans suboptimal. As will be further apparent from the following description, asset management system 40 is configured to provide a posteriori contextual information to assist a user in redefining zones or boundaries at the work site in response to changed conditions.

As suggested above, changed conditions can include changed terrain conditions such as a changed working face location, changed elevation profiles, changes in material composition, consistency, or moisture content, changes in the location of stationary equipment such as a crusher or other material processing equipment, or still others. Additional a posteriori changed conditions can include user-specified conditions, such as conditions observed by personnel, or by field devices such as drones, handheld mobile computer devices, or still others. Embodiments are also contemplated where a posteriori data is gathered by machine assets 10, 12 and 14, 16 themselves. In the example of FIG. 1, a changed location of the working face from the prior working face 124 to the present working face 24 can mean that loader 10 is now operating outside of an earlier defined zone where performance data is gathered. The discovery of boulders 26 could justify redrawing zones or boundaries as well.

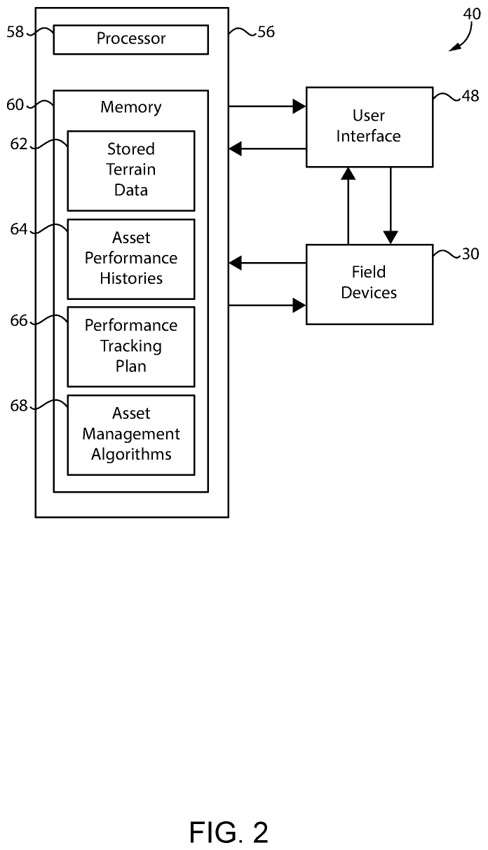

Referring also now to FIG. 2, there is shown a block diagram illustrating elements of asset management system 40. The user interface is shown at a block 48, and field devices are shown at a block 30. Also depicted in FIG. 2 is a controller 60. Controller 60 can include any suitable computerized controller having a central processing unit (CPU), and could be resident on server computer 54, user computer 42, a desktop computer at a site management office, a handheld mobile device, or elsewhere. Any of the various functions of asset management system 40 might be executed in part on one computer, and in part on another computer. In a practical implementation strategy, controller 56 is resident on or in communication with server computer 54 and receives location information from the machine assets of machine system 8, and receives contextual information from field devices, or from a user inputted by way of user interface 48. Processor 58 can include any suitable data processor, such as a microprocessor, a microcontroller, or still another. Controller 56 also includes a memory 60. Memory 60 can be any suitable machine-readable memory, such as RAM, ROM, EEPROM, DRAM, SDRAM, a hard drive, et cetera. Memory 60 stores information relevant to the operation of asset management system 40, including stored terrain data 62, asset performance histories 64, and a performance tracking plan 66. Memory 60 also stores an asset management algorithm 68 executed by processor 58, for example, as further discussed herein.

It will thus be appreciated that asset management system 40 includes at least one computer coupled with user interface 48. The at least one computer is structured to display, on user interface 48, a graphical map representation of a work site based upon stored terrain data. A graphical map representation could include a birds-eye view, one or more profiles, or still another. Terrain data as contemplated herein can include map image data, elevation data, geolocation data, profile data, or any other form of terrain data. In one implementation stored terrain data includes a visual map based on satellite images captured at a given point in time. The at least one computer is further structured to populate the graphical map representation displayed on user interface 48 with a posteriori contextual image cues. The at least one computer is further structured to receive user-specified location parameters defining at least one of a zone or a boundary at the work site, and update a performance tracking plan based upon the at least one of a zone or a boundary at the work site. The at least one computer is further structured to store a history of asset performance at the work site based upon the updated performance tracking plan.

Storing a history of asset performance may include storing, locally on a computer readable memory, on a remote server, or in cloud storage, for example, asset activities such as material handling activities, asset states such as machine speeds, load weights or bucket or bed fill proportions, fuel consumption or efficiency, transmission gear, acceleration, braking, or virtually any other conceivable asset or operator behavior or condition that can be associated with a machine asset. A history of asset performance means that asset performance data is gathered and stored a plurality of times, or for a time duration. As also explained herein a history of asset performance can include stored events, such as a count of events, and could also include aggregated or normalized data, for example, a mean travel speed, mean loading and/or dumping cycle time, or various other measures of central tendency such as median or mode, as well as minimum and maximum conditions, for instance, such as minimum or maximum cycle times, minimum or maximum speeds, etc. The performance tracking plan specifies what activities or what data is to be stored, and under what conditions. For example, a performance tracking plan might specify that loading operations and dumping operations are to be counted for a given machine asset based upon location of the machine asset and/or entry and/or exit from a geolocation zone or crossing of a boundary. Loads might be counted inside a first geolocation zone, and dumps counted in a second geolocation zone. A dump inside the first geolocation zone would not be counted, or would be counted a different way, as such a dump might be unintentional or a correction by an operator. Triggering of the acquisition of asset performance data, of any type, and/or storing in history is thus based upon boundary and/or zone information. When the performance tracking plan is updated different criteria, such as new boundaries of one or more geolocation zones, can be applied, as further discussed herein.

As discussed above, the a posteriori contextual image cues can include a variety of different cues based upon a variety of different types of data. In an implementation, the a posteriori contextual image cues include at least one of an asset activity cue, a terrain cue, a boundary cue, or a site condition cue. As also discussed above, the a posteriori contextual image cues can be generated based upon data acquired from field devices, from machine assets, or based upon observations or information known to a user. The subject data can be uploaded to controller 56 from the various data sources, and can thus include uploaded asset activity data, uploaded terrain data, uploaded boundary data, or uploaded site condition data. Uploaded asset activity data can include, for example, paths traversed by any of the machine assets of machine system 8, locations of any of the machine assets of machine system 8, the operations of any of the machine assets of machine system 8 such as loading operations, dumping operations, counts of loading and/or dumping operations, or other material handling operations or activities such as material spreading, leveling, compaction, moisture manipulation, or still others. The uploaded terrain data can include elevation data, profile data, aspect ratio data, slope data, or still others. The uploaded boundary data could include boundaries specified or suggested by a field service personnel, for example, or a boundary location specified by a tracked travel path of a machine asset, for example. The site condition data could include the presence or absence of objects, the presence or absence of machinery, material moisture content, material type, material composition or consistency, or still others. In one implementation, an uploaded boundary data example includes a user-drawn boundary of a geolocation zone. It will be recalled that zones used in gathering performance data can be initially specified. Field service personnel and/or machines could be tasked with observing or traveling around a work site to make observations and upload boundary data or site condition data that has changed based upon the discovery of new information as the work site changes over time, or for other reasons. In one example, field service personnel and/or machines could tag, using a geolocation tag, different locations at the work site, for use in populating a graphical map representation with a posteriori contextual image cues.

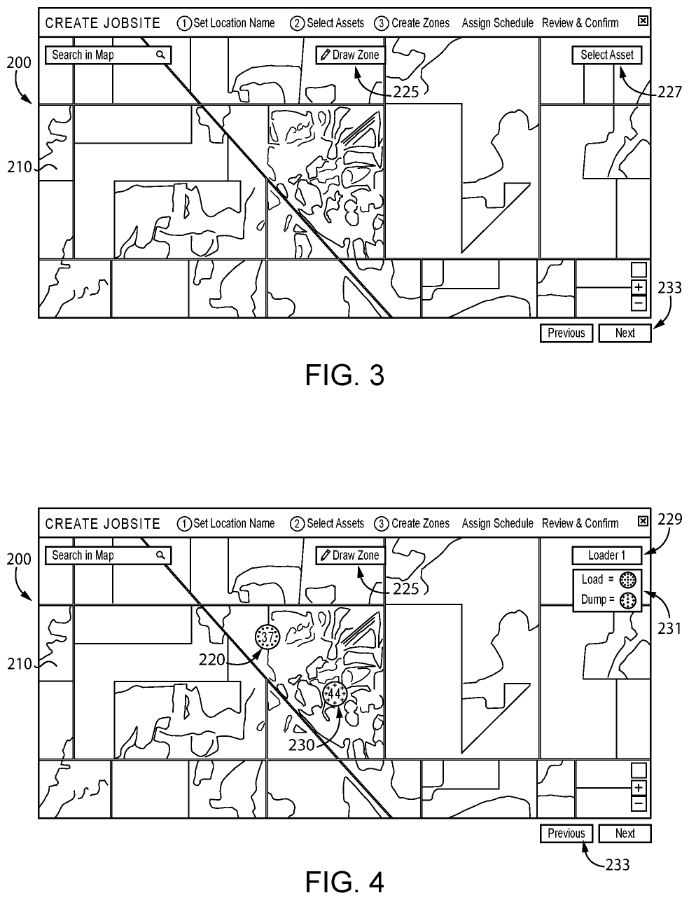

Referring also now to FIG. 3, there is shown a graphical display 200 including a graphical map representation 210 of a work site as it might be displayed on user interface 48. Graphical map display 210 may be interactive and include various features whereby a user can activate aspects of the software, enter information, change views, and draw boundaries or zones as further discussed herein. In FIG. 3 an asset selection button is shown at 227, and navigation buttons are shown at 233. A draw zone button is shown at 225. A user can activate a draw zone function of asset management system 40 using draw zone button 225. Referring also now to FIG. 4, there it can be seen that a selected asset Loader 1 is shown at 229, and a key is shown at 231. Key 231 indicates a color, shading, stippling, or other scheme visually perceptible to an operator for displaying a posteriori contextual image cues to an operator, presently indicating that a load activity is shown in light blue or dotted stippling and that a dump activity is shown in purple or crossed-line stippling. Loads are shown at contextual image cue 220, including a count of loads or loading operations, and dumps are shown at contextual image cue 230 including a count of dumps or dumping operations. In the illustrated case Loader 1 has loaded 37 loads at the location indicated by cue 220, and has dumped 44 loads at the location indicated by cue 230.

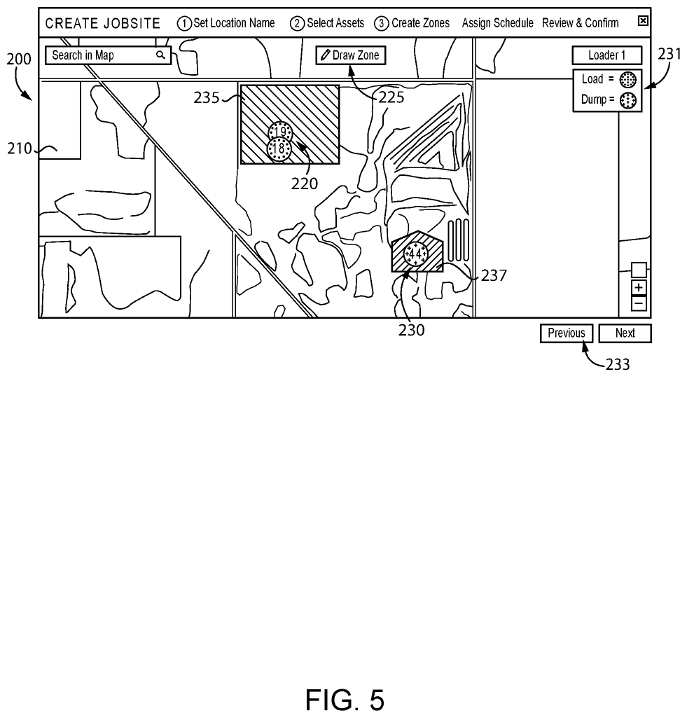

Turning now to FIG. 5, there is shown graphical map representation 210 as it might appear populated with a posteriori contextual image cues, and also where a user has inputted user-specified location parameters. In the illustrated case, the user-specified location parameters have defined a first zone 235 and a second zone 237. Graphical map representation 210 is also enlarged relative to that shown in FIG. 3 and FIG. 4, and cue 220 has been subdivided into two location cues showing different locations of 19 loads and 18 loads. Cue 230 is shown within zone 237. From the state depicted in FIG. 5, a user could use navigation buttons 233 to advance to a save or execute screen where the stored performance tracking plan is updated based upon the creation of zones 235 and 237. As machine system 8 is operated, data can be gathered, aggregated, quantified, or otherwise utilized based upon the exit and entry of one or more machines, in the illustrated case Loader 1, relative to zones 235 and 237. Entry and exit can be determined based upon global or local position tracking of Loader 1 in comparison to the user-specified boundaries of the subject zones, for example.

It should be appreciated that rather than two zone creations for one loader machine many different zones applicable to performance monitoring and reporting could be utilized, with a variety of different zones or boundaries triggering performance data acquisition when entered or exited by different machines. It will thus be further appreciated that a user could go back to the graphical map representation shown in FIG. 3, select a different asset, and create one or more zones or boundaries based upon the a posteriori contextual image cues provided. It will further be appreciated that rather than or in addition to load locations and numbers and dump locations and numbers, graphical map representation 210 could be populated with elevation boundaries, slopes, images depicting obstacles, objects, the presence of processing equipment, lines scouted by field service personnel, and all manner of other information.

### INDUSTRIAL APPLICABILITY

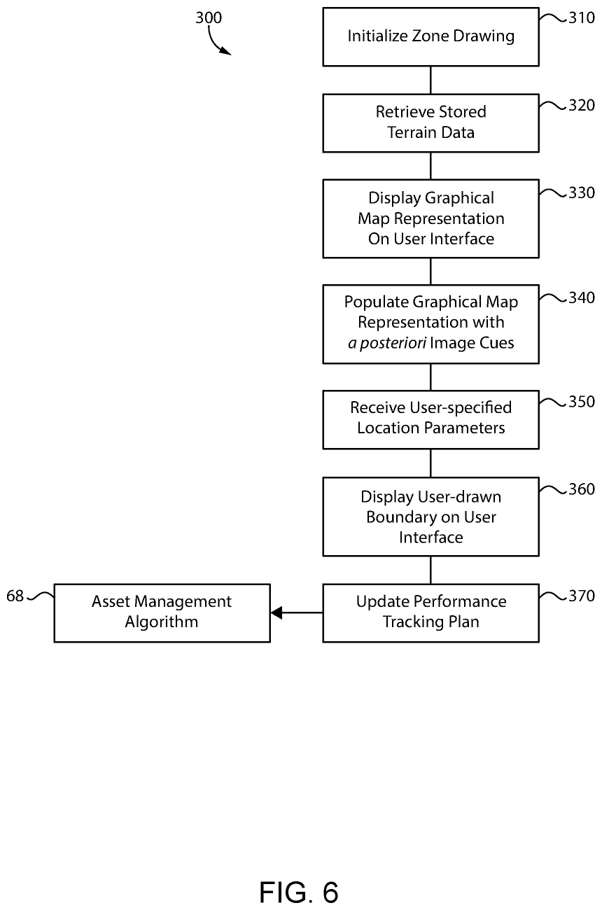

Referring to the drawings generally, but in particular to FIG. 6, there is shown is a flowchart 300 illustrating example methodology and logic flow according to one embodiment. Flowchart 300 includes a block 310 where zone drawing is initialized. Initialization of zone drawing could include a user interacting with draw zone button 325 as discussed above. From block 310 flowchart 300 may advance to block 320 to retrieve stored terrain data as discussed herein, and thenceforth to a block 330 to display graphical map representation on user interface 48.

Simultaneous with the initial display of graphical map representation at block 330, or subsequently, flowchart 300 advances to a block 340 to populate the graphical map representation with a posteriori contextual image cues. From block 340 flowchart 300 advances to a block 350 to receive user-specified location parameters. It will be appreciated that the user-specified location parameters can include locations, orientations, trajectories, curvatures, or other properties of a boundary or a geolocation zone. From block 350, flowchart 300 can advance to a block 360 to display user-drawn boundary on the user interface. It will be noted that FIG. 5 depicts the display of user-specified zones which include user-drawn boundaries. From block 360 the process may advance to a block 370 to update the stored performance tracking plan as discussed herein. Flowchart 300 also depicts an output from the updated performance tracking plan to asset management algorithm 68, to be executed by controller 56 based upon the updated information available.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of managing assets at a work site comprising:
displaying, on a user interface, a graphical map representation of a work site based upon stored terrain data;
populating the graphical map representation displayed on the user interface with a posteriori contextual image cues;
receiving user-specified location parameters defining at least one of a zone or a boundary at the work site;
updating a performance tracking plan based upon the at least one of a zone or a boundary at the work site; and
storing a history of asset performance at the work site based upon the updated performance tracking plan.

2. The method of claim 1 further comprising uploading at least one of asset activity data, terrain data, boundary data, or site condition data, and the a posteriori contextual image cues are based upon at least one of the uploaded asset activity data, uploaded terrain data, uploaded boundary data, or uploaded site condition data.

3. The method of claim 2 wherein the uploaded terrain data is indicative, relative to the stored terrain data, of a changed terrain condition.

4. The method of claim 2 wherein the site condition data includes a geolocation tag.

5. The method of claim 2 wherein the asset activity data includes at least one of location data or material handling data for each of a plurality of assets at the work site.

6. The method of claim 1 further comprising displaying, on the user interface, a graphical representation of the user-specified location parameters.

7. The method of claim 6 wherein the displaying of the graphical representation of the user-specified location parameters includes displaying a user-drawn boundary inputted by way of the user interface.

8. A work site productivity management system comprising:
a user interface including a display;
at least one computer coupled with the user interface, and structured to:
display, on the user interface, a graphical map representation of a work site based upon stored terrain data;
populate the graphical map representation displayed on the user interface with a posteriori contextual image cues;
receive user-specified location parameters defining at least one of a zone or a boundary at the work site;
update a performance tracking plan based upon the at least one of a zone or a boundary at the work site; and
store a history of asset performance at the work site based upon the updated performance tracking plan.

9. The system of claim 8 wherein the at least one computer is further structured to:
receive at least one of uploaded asset activity data, uploaded terrain data, uploaded boundary data, or uploaded site condition data; and
populate the graphical map representation with a posteriori contextual image cues based upon at least one of the uploaded asset activity data, uploaded terrain data, uploaded boundary data, or uploaded site condition data.

10. The system of claim 9 wherein the at least one computer is further structured to display, on the user interface, a graphical representation of the user-specified location parameters.

11. The system of claim 10 wherein the graphical representation of the user-specified location parameters includes a user-drawn boundary, and the at least one computer is further structured to update the performance tracking plan based upon the user-drawn boundary.

12. The system of claim 11 wherein the user-drawn boundary is a user-drawn boundary of a geolocation zone.

13. The system of claim 12 wherein the at least one computer is further structured to track asset performance based upon entry or exit of assets from the geolocation zone, and to store the history of asset performance based upon the tracked asset performance.

14. The system of claim 9 wherein the at least one computer is structured to populate the graphical map representation with a posteriori contextual image cues based on the asset activity data.

15. The system of claim 14 wherein the asset activity data includes location data and material handling data for each of a plurality of assets at the work site.

16. The system of claim 15 wherein the material handling data includes at least one of a count of loading operations or a count of dumping operations for each of the plurality of assets at the work site.

17. A machine system comprising:
a plurality of machine assets each structured for material handling at a work site;
an asset management system including a user interface having a display, and at least one computer coupled with the user interface, the at least one computer being structured to:
display, on the user interface, a graphical map representation of the work site based upon the stored terrain data;
populate the graphical map representation displayed on the user interface with a posteriori contextual image cues;
receive user-specified location parameters defining at least one of a zone or a boundary at the work site;
update a performance tracking plan based upon the at least one of a zone or a boundary at the work site; and
store a history of asset performance at the work site based upon the updated performance tracking plan.

18. The machine system of claim 17 wherein the plurality of machine assets includes a loader machine and a hauler machine.

19. The machine system of claim 17 wherein the a posteriori contextual image cues include at least one of an asset activity cue, a terrain cue, a boundary cue, or a site condition cue.

20. The machine system of claim 18 wherein the a posteriori contextual image cues include at least one of a count of loading operations or a count of dumping operations.
